(19) United States
(12) Patent Application Publication
(10) Pub. No.: US 2025/0065621 A1
(43) Pub. Date: Feb. 27, 2025

(54) LIQUID EJECTION HEAD AND LIQUID EJECTION APPARATUS

(71) Applicant: CANON KABUSHIKI KAISHA, Tokyo (JP)

(72) Inventor: RYOTARO MURAKAMI, Kanagawa (JP)

(21) Appl. No.: 18/791,712

(22) Filed: Aug. 1, 2024

(30) Foreign Application Priority Data
Aug. 25, 2023 (JP) 2023-137462

(51) Int. Cl. B41J 2/14; B41J 2/16

(52) U.S. Cl. CPC B41J 2/14; B41J 2/1623; B41J 2002/14467; B41J 2202/11; B41J 2202/12; B41J 2202/22

(57) ABSTRACT

In a liquid ejection head including a liquid ejection substrate configured to eject liquid, the liquid ejection substrate is configured to include a first substrate in which a channel for the liquid is formed and a second substrate joined to a first surface of the first substrate via an adhesive agent, the first substrate has, as viewed in a direction perpendicular to the first surface, a channel region including a plurality of the channels for the liquid and a partition sectioning the adjacent channels for the liquid from each other and a joining region adjacent to the channel region and including a recess portion open on the first surface, and the adhesive agent is accommodated in the recess portion.

### BACKGROUND OF THE INVENTION

### Field of the Invention

The present disclosure relates to a liquid ejection head and a liquid ejection apparatus, in detail, relates to a technique of stacking multiple substrates forming the liquid ejection head and adhering them to each other.

### Description of the Related Art

Among liquid ejection heads, there is a liquid ejection head formed by stacking a channel substrate on a support substrate, the channel substrate being a substrate in which channels for supplying liquid such as ink to ejection ports and the like are formed. Japanese Patent Laid-Open No. 2023-061022 describes joining these stacked substrates to each other with an adhesive agent. In detail, undulation of an adhesive layer in transfer of the adhesive layer to the substrate is controlled to suppress protruding of the adhesive agent from an adhesion portion.

However, protruding of the adhesive agent is desirable in some cases. Specifically, the protruding adhesive agent moves on the support substrate and walls of a partition forming channels in a channel formation substrate, and forms an adhesion layer not only in an adhesion portion of the partition but also in portions continuous with the adhesion portion. A portion of the adhesive layer that prevents ink leak can be thus made large by the above-mentioned protruding, and ink leak between the adjacent channels through the partition can be prevented. It can be said from this viewpoint that a large amount of the protruding of the adhesive agent onto the walls of partition and the support substrate is desirable as long as there are no adverse effects such as blocking of the channel.

However, in the case where the amount of adhesive agent is increased to increase the protruding of the adhesive agent formed around the partition, a large amount of adhesive agent is put into also a portion where no channel is formed such as the partition of the channel formation substrate, for example, a joining region to which the support substrate is to be joined. As a result, there is a possibility that a large amount of adhesive agent protrudes to the channel adjacent to the joining region and the like, and adverse effects such as blocking of the channel occurs.

### SUMMARY OF THE INVENTION

In a liquid ejection head including a liquid ejection substrate configured to eject liquid in a present disclosure, the liquid ejection substrate is configured to include a first substrate in which a channel for the liquid is formed and a second substrate joined to a first surface of the first substrate via an adhesive agent, the first substrate has, as viewed in a direction perpendicular to the first surface, a channel region including a plurality of the channels for the liquid and a partition sectioning the adjacent channels for the liquid from each other and a joining region adjacent to the channel region and including a recess portion open on the first surface, and the adhesive agent is accommodated in the recess portion.

Further features of the invention will become apparent from the following description of exemplary embodiments with reference to the attached drawings.

### BRIEF DESCRIPTION OF THE DRAWINGS

FIG. 1 is a perspective diagram illustrating part of a liquid ejection substrate forming a liquid ejection head according to a first embodiment of the present disclosure at a cross section;

FIG. 2 is a cross-sectional diagram of the part of the liquid ejection substrate illustrated in FIG. 1;

FIG. 3 is a diagram illustrating an A portion of the liquid ejection substrate illustrated in FIG. 2;

FIG. 4A is a diagram of a channel formation substrate of the liquid ejection substrate illustrated in FIG. 1, as viewed from the lower surface side of the channel formation substrate;

FIG. 4B is an enlarged diagram of a B portion in FIG. 4A;

FIG. 5 is a diagram illustrating a state where two of the liquid ejection substrates illustrated in FIG. 4A are joined to each other;

FIG. 6 is an enlarged diagram of a C portion in FIG. 5;

FIG. 7 is a diagram schematically illustrating some of recess portions in a joining region of FIG. 4B;

FIG. 8 is a diagram illustrating a liquid ejection substrate according to a second embodiment of the present disclosure;

FIG. 9 is a perspective diagram illustrating a liquid ejection head according to one embodiment of the present disclosure; and

FIG. 10 is a perspective diagram schematically illustrating an inkjet printing apparatus according to one embodiment of the liquid ejection apparatus.

### DESCRIPTION OF THE EMBODIMENTS

Embodiments of the present disclosure are explained below in detail with reference to the drawings. Note that dimensions, material, and shape of each of components in the embodiments described below, arrangement of the components relative to one another, and the like may be changed as appropriate depending on configurations and various conditions of a liquid ejection substrate and the like in a liquid ejection head to which the present disclosure is applied. The scope of the present disclosure is not limited to the embodiments described below.

### Embodiment 1

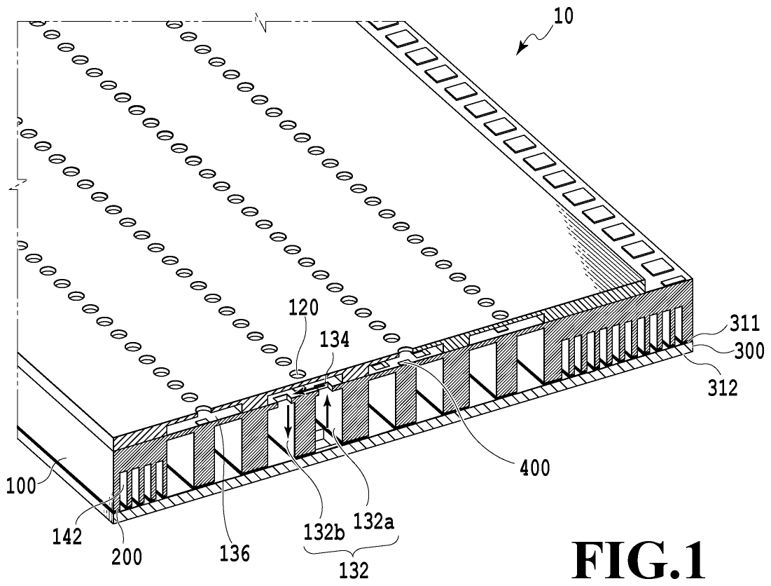

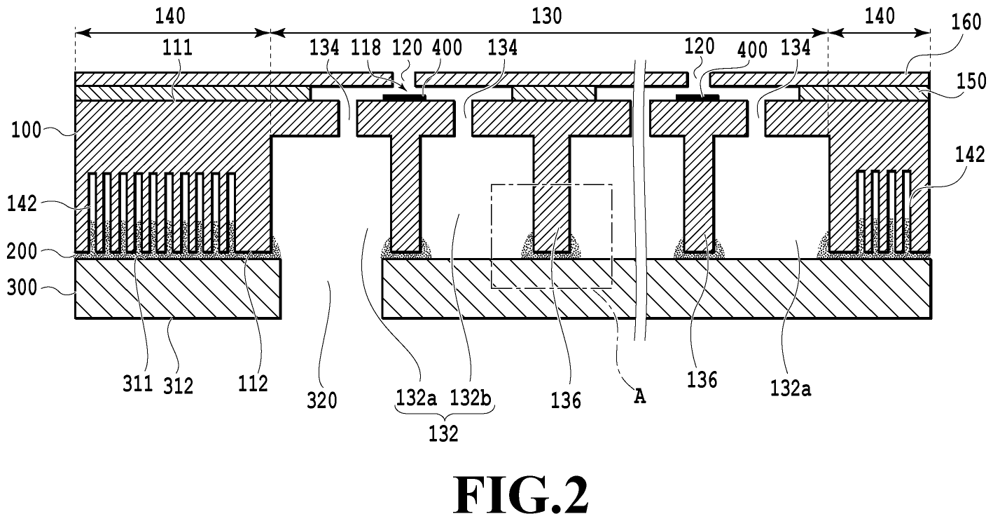

FIG. 1 is a perspective diagram illustrating part of a liquid ejection substrate forming a liquid ejection head according to the embodiment at a cross section, and FIG. 2 is a cross-sectional diagram of the part of the liquid ejection substrate illustrated in FIG. 1. As illustrated in FIGS. 1 and 2, the liquid ejection substrate 10 includes a channel formation substrate (hereinafter, also referred to as first substrate) 100, a support substrate (hereinafter, also referred to as second substrate) 300 joined to the channel formation substrate 100 via an adhesive agent 200, and energy generation elements 400 provided on the channel formation substrate 100 and configured to generate energy used to eject liquid.

The liquid ejection substrate 10 of the embodiment is used by being attached to an inkjet printing apparatus being a liquid ejection apparatus, and ejects ink as the liquid.

A channel layer 150 and a nozzle layer 160 are stacked on an upper surface (hereinafter, also referred to as first surface) 111 of the channel formation substrate 100 in a range corresponding to portions to be formed by the channel layer 150 and the nozzle layer 160, and ejection ports 120, pressure chambers 118, and the like are formed. A lower surface (hereinafter, also referred to as second surface) 112 of the channel formation substrate 100 is joined to the support substrate 300 via the adhesive agent 200 depending on each of portions as described later. Moreover, a pitch conversion channel 320 connected to common channels 132 formed in the channel formation substrate 100 is formed in the support substrate 300.

As illustrated in FIG. 2, the liquid ejection substrate 10 according to the embodiment explained above is sectioned into a channel region 130 and joining regions 140 in a direction orthogonal to an arrangement direction of the ejection ports 120.

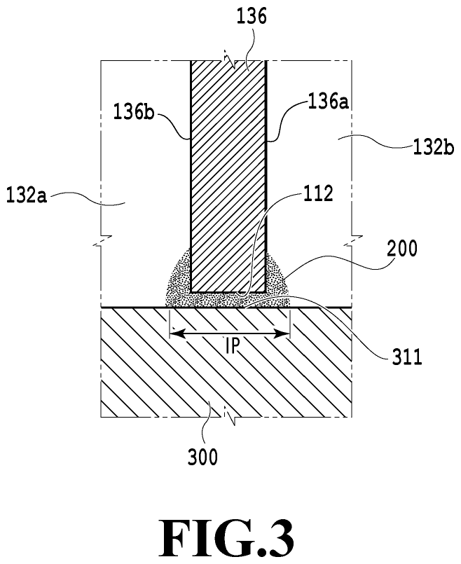

In the channel region 130, there are the common channels 132 for supplying the liquid to the energy generation elements 400, individual channels 134 communicating with the common channels 132, and the pressure chambers 118 in which the energy generation elements 400 are provided. The liquid reaches the pressure chambers 118 from the common channels 132 by passing the individual channels 134, and the energy generation elements 400 cause the liquid reaching pressure chambers 118 to be ejected from the ejection ports 120 communicating with the pressure chambers 118 by generating energy. Moreover, the common channels 132 includes a supply channel 132a for supplying the liquid to the energy generation elements 400 and a collecting channel 132b for collecting the liquid supplied to the energy generation elements 400 and not used in the ejection. As described above, the channel region 130 is a region in which the lower surface 112 at partitions 136 for forming the channels is joined to the support substrate 300 by the adhesive agent 200. FIG. 3 is a diagram illustrating an A portion of the liquid ejection substrate illustrated in FIG. 2. The lower surface 112 at the partition 136 in the channel formation substrate 100 is joined to an upper surface (hereinafter, also referred to as third surface) 311 of the support substrate 300 via the adhesive agent 200. In this case, the protruding adhesive agent moves to lower portions of both side walls 136a and 136b of the partition 136 forming the common channels 132 and to a portion of the upper surface 311 of the support substrate 300 adjacent to the partition 136, and is cured. As a result, an ink leak path IP being a path in which flow-in and flow-out of the ink between the channels is to be prevented can be made longer, and a liquid ejection head with high reliability with no unnecessary flow-in or flow-out of the ink can be obtained. Note that, in a form in which different types of liquids flow through the common channels 132, the protruding of the adhesive agent in the portion of the partition 136 can also prevent adverse effects such as mixing of the liquids and a decrease in circulation flow rate of each of the different types of liquids.

Referring to FIGS. 1 and 2 again, the joining regions 140 are each a region that is adjacent to the channels only on one side in the channel formation substrate 100. Specifically, a portion of this region where the lower surface 112 of the channel formation substrate 100 is joined to the support substrate 300 is a region where the ink cannot flow by passing through this joining portion. Multiple recess portions (grooves) 142 that receive the adhesive agent are provided on the lower surface side of the channel formation substrate 100 in this region. Specifically, in the case where the lower surface 112 of the channel formation substrate 100 is joined to the upper surface 311 of the support substrate 300 via the adhesive agent 200, the recess portions 142 receive particularly the adhesive agent 200 coated on the portion of the joining region 140 adjacent to the common channel 132. This can suppress protruding of the adhesive agent to the common channel 132 adjacent to the joining region 140, and prevent a situation where the channel is blocked by the adhesive agent.

Note that, although the energy generation elements 400 in the embodiment are heat generating resistors, the energy generation elements 400 may have another form and be, for example, piezoelectric elements. Moreover, wiring, pads for electrode connection, and the like that supply electric power to the energy generation elements 400 are not illustrated. A material with high adhesiveness to the channel formation substrate 100 and the support substrate 300 is preferably used as the adhesive agent 200. The adhesive agent 200 is preferably a material with high coating performance and with little mixing of air bubbles and the like, and is preferably a material with a viscosity so low that the adhesive agent 200 can be easily made to have a small thickness. For example, the adhesive agent 200 may include any of the resins selected from the group consisting of an epoxy resin, an acrylic resin, a silicone resin, a benzocyclobutene resin, a polyamide resin, a polyimide resin, and a urethane resin.

Moreover, the curing method of the adhesive agent 200 may be a thermal setting method or a delayed ultraviolet curing method. Note that, in the case where the channel formation substrate 100 or the support substrate 300 can transmit ultraviolet rays, an ultraviolet curing method may be used as the curing method of the adhesive agent 200.

Furthermore, an adhesive agent transfer method using a used substrate can be given as the method of applying the adhesive agent 200. Specifically, a transfer substrate is prepared, and the adhesive agent 200 is thinly and uniformly coated onto the transfer substrate by a spin coating method or a slit coating method. Then, the second surface 112 of the channel formation substrate 100 is brought into contact with the coated adhesive agent 200, and the adhesive agent 200 can be thereby transferred only to the second surface 112 of the channel formation substrate 100. The size of the transfer substrate is preferably equal to or larger than the dimensions of the channel formation substrate 100. A film of silicon, glass, PET, PEN, PI, or the like is preferably used as the transfer substrate. Moreover, screen printing and dispense coating can be given as the method of directly forming the adhesive agent 200 on the channel formation substrate 100. Although the explanation is given above by using the channel formation substrate 100, the adhesive agent can be coated onto the third surface 311 of the support substrate 300 for joining with the channel formation substrate 100 as the same coating method.

Note that the joining of the support substrate 300 and the channel formation substrate 100 coated with the adhesive agent 200 is performed such that the channel formation substrate 100 and the support substrate 300 are heated to predetermined temperature in a joining apparatus, and then subjected to pressure application at certain pressure for certain time. These joining parameters are appropriately set depending on the adhesive agent material. Moreover, the channel formation substrate 100 and the support substrate 300 are preferably joined in vacuum to suppress mixing of air bubbles into a joining portion of the channel formation substrate 100 and the support substrate 300.

In the case where the adhesive agent 200 is a thermal setting adhesive agent, the adhesive agent 200 may be heated until it is cured in the joining apparatus. The curing of the adhesive agent 200 may be promoted by taking out a substrate joined body and separately heating the substrate joined body in an oven or the like after the joining. Meanwhile, in the case where the adhesive agent 200 is a delayed ultraviolet curing adhesive agent, the adhesive agent 200 is irradiated with a defined amount of an ultraviolet ray by before the joining of the channel formation substrate 100 and the support substrate 300, and then the support substrate 300 is joined to the channel formation substrate 100. After the joining of the support substrate 300 to the channel formation substrate 100, the substrate joined body is preferably further heated to sufficiently promote the curing of the adhesive agent 200. In the case where the adhesive agent 200 is an ultraviolet curing adhesive agent, the channel formation substrate 100 and the support substrate 300 are joined to each other, and then the adhesive agent 200 on the substrate (channel formation substrate 100 and/or the support substrate 300) that transmits the ultraviolet ray, to cure the adhesive agent 200 is irradiated with a defined amount of an ultraviolet ray. After the joining of the support substrate 300 to the channel formation substrate 100, the substrate joined body is preferably further heated to sufficiently promote the curing of the adhesive agent 200.

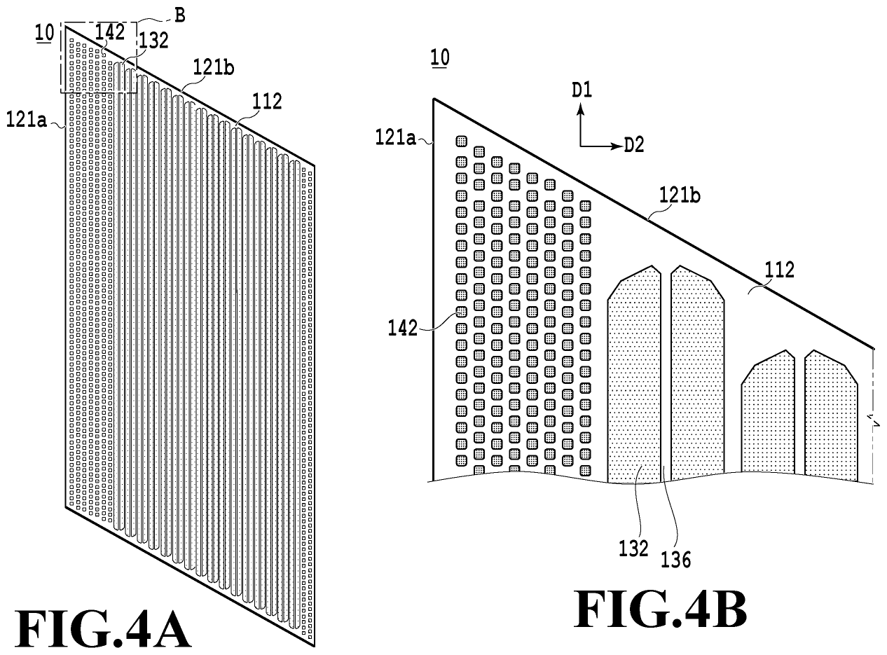

FIG. 4A is a diagram of the channel formation substrate 100 of the liquid ejection substrate 10 illustrated in FIG. 1, as viewed from the lower surface side of the channel formation substrate 100. FIG. 4B illustrates an enlarged diagram of a B portion in FIG. 4A. As illustrated in FIGS. 4A and 4B, multiple recess portions 142 are arranged in a staggered pattern, and this arrangement maintains the stiffness of the substrate. Specifically, in the case where the longitudinal direction of the common channels 132 is a first direction D1, the recess portions 142 are continuously aligned in the first direction D1 while being aligned with the recess portions 142 in every other row, in a second direction D2 orthogonal to the first direction D1. Moreover, in the embodiment, the recess portions 142 are aligned along a longitudinal direction end portion 121a of the channel formation substrate 100.

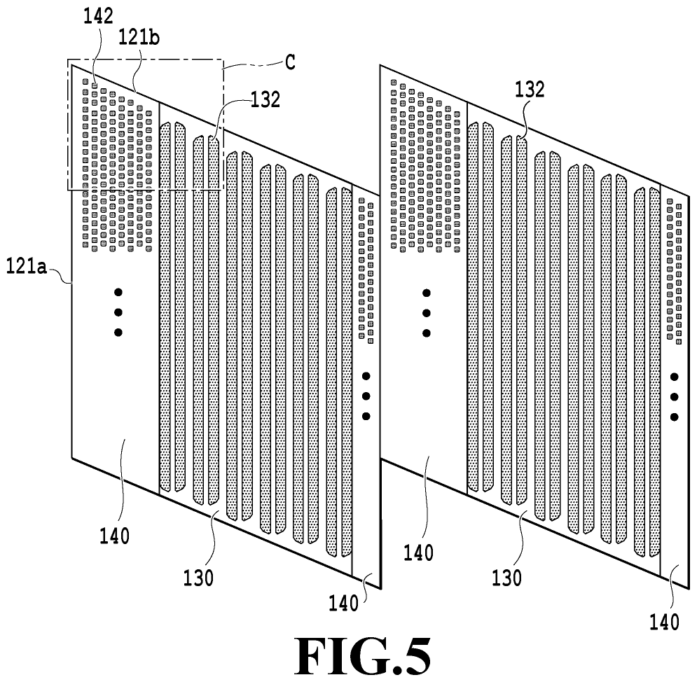

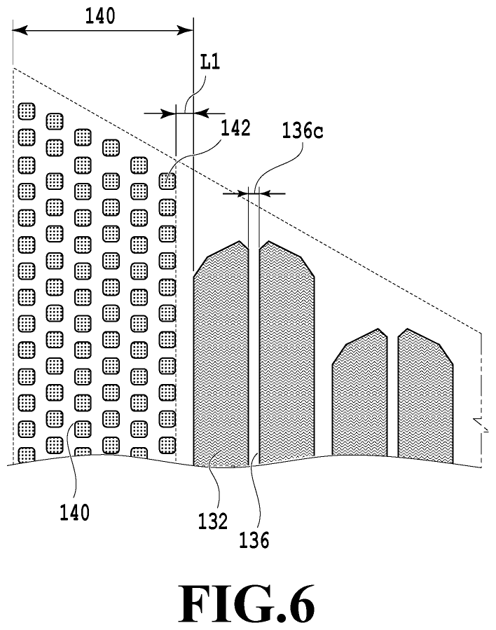

FIG. 5 is a diagram illustrating a state where two of the liquid ejection substrates illustrated in FIG. 4A are joined to each other, and the support substrate 300 is omitted in the illustration of FIG. 5. Moreover, FIG. 6 is an enlarged diagram of a C portion in FIG. 5. As illustrated in FIGS. 5 and 6, the recess portions 142 are formed in the joining regions 140 where no common channels 132 are formed. In this case, a distance L1 between an end of each recess portion 142 closest to the common channel in the array of the recess portions 142 and an end of the common channel 132 adjacent to this recess portion 142 is set to be longer than the width 136c of the partition 136. An adhesion surface area that enables stable joining of the channel formation substrate 100 and the support substrate 300 can be thereby secured. As a result, an adhesion surface area of a region of the distance L1 between the recess portion 142 and the partition 136 can be made larger than an adhesion surface area of one partition 136, and a liquid ejection head with high reliability can be obtained.

Moreover, assume a case where no recess portions 142 are provided in the channel formation substrate 100 in the configuration of the embodiment. In this case, if the length of a region coated with the adhesive agent in the same direction as the above-mentioned distance L1 is 150 μm or more and the thickness of the adhesive agent 200 is between 0.5 μm and 4.0 μm, the adhesive agent that will not be accommodated in the recess portions due to absence of the recess portions 142 may protrude toward the common channel 132 and block the common channel 132. Specifically, it is desirable that the recess portions 142 are provided in the joining regions 140 of the channel formation substrate 100 in the case where the above-mentioned length of the coating region is 150 μm or more and the thickness of the adhesive agent 200 is 0.5 μm to 4.0 μm.

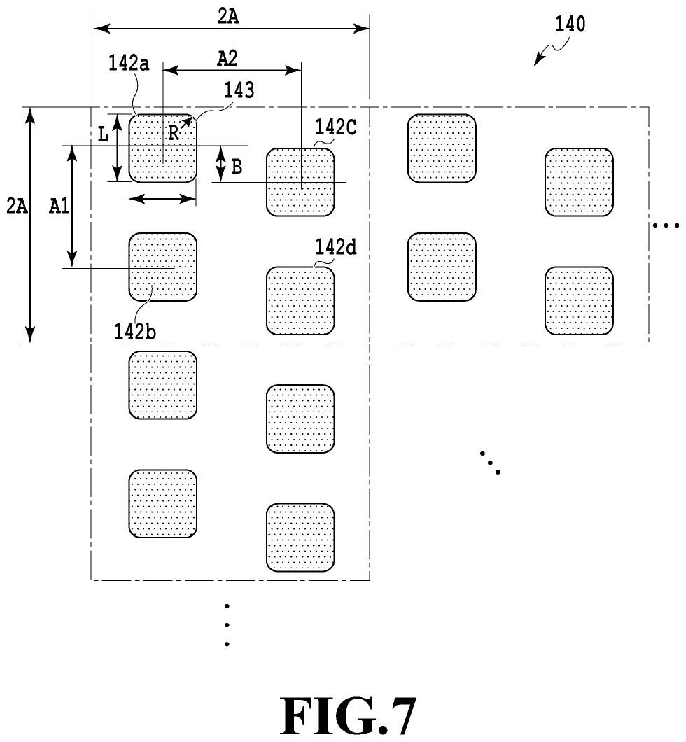

FIG. 7 is a diagram schematically illustrating some of the recess portions 142 in the joining region of FIG. 4B. As illustrated in FIG. 7, the recess portions 142a, 142b, 142c, and 142d have a square shape in which the length L of one side is in a range of 10 μm to 50 μm, and four corner portions 143 of each recess portion 142 may have an arc shape. Moreover, an opening ratio of the recess portions 142a, 142b, 142c, and 142d per unit area in the joining region 140 is 5% to 30%. Specifically, the area of the recess portions 142a, 142b, 142c, and 142d is 5% to 30% per unit area of the joining region 140. As illustrated in FIG. 7, the unit area is an area of a quadrangle shape that includes the four recess portions 142a, 142b, 142c, and 142d and that has two sides with the length of 2 A. The above-mentioned opening ratio may be comprehensively determined in view of the amount of the adhesive agent 200 to be transferred, opening shapes of the channels, an allowable protruding amount of the adhesive agent, and the like.

Moreover, in the embodiment, the length L of one side of the recess portions 142a, 142b, 142c, and 142d is 30 μm, and the arc length R of the corner portions 143 is 6 μm. A distance A1 between the centers of the adjacent two recess portions 142a and 142b along the longitudinal direction end portion 121a of the channel formation substrate 100 is 90 μm, and a distance A2 between the centers of the two adjacent recess portions 142a and 142c along a transverse direction end portion 121b of the channel formation substrate 100 is 90 μm. A shift amount B of the centers of the two recess portions 142a and 142c adjacent along the transverse direction end portion 121b (see FIG. 4B) of the channel formation substrate 100 is 37.5 μm.

In the case where the four recess portions 142a, 142b, 142c, and 142d are set as one set as illustrated in FIG. 7, this set has a square shape, the length 2A of one side of this set is 180 μm, and this set is arranged inside the joining region 140 as illustrated in FIG. 4B. The opening ratio of the recess portions 142a, 142b, 142c, and 142d per unit area in this case is 10%. Specifically, the area of the recess portions 142a, 142b, 142c, and 142d is about 10% of the unit area of the joining regions 140. Other dimensional examples are illustrated in the following table 1.

TABLE 1

| | (1) | (2) | (3) | (4) | (5) | (6) | (7) | (8) | (9) | (10) | (11) |
|---|---|---|---|---|---|---|---|---|---|---|---|
| Opening | 5% | 10% | 15% | 10% | 5% | 10% | 15% | 5% | 10% | 15% | 15% |
| ratio | | | | | | | | | | | |
| L | 10 | 10 | 10 | 20 | 30 | 30 | 30 | 50 | 50 | 50 | 50 |
| R | 2 | 2 | 2 | 4 | 6 | 6 | 6 | 10 | 10 | 10 | 10 |
| A | 45 | 30 | 26 | 60 | 135 | 90 | 78 | 225 | 150 | 130 | 130 |
| B | 17.5 | 12.5 | 10 | 25 | 52.5 | 37.5 | 30 | 87.5 | 62.5 | 50 | 50 |

Unit [μm]

Regarding a method of manufacturing the liquid ejection substrate of the liquid ejection head in the embodiment, the energy generation elements 400 that are used to eject liquid droplets and that are made of TaSiN, an electric circuit (not illustrated) that drives the energy generation elements 400, and an electrical connection portion (not illustrated) that is electrically connected to an electrical connection substrate are formed in the channel formation substrate 100. In detail, the channel formation substrate 100 may be made of silicon and subjected to a thickness reduction process by a grinding apparatus until the thickness of the substrate reaches 625 μm.

Moreover, the channels for allowing flow of the liquid and the recess portions 142 for accommodating the adhesive agent 200 are formed in the channel formation substrate 100. Specifically, Bosch process that is one type of reactive ion etching or anisotropic etching with TMAH or KOH is performed to form the recess portions 142 for accommodating the adhesive agent 200 or the channels for allowing flow of the liquid. In Bosch process, vertical etching grooves can be formed in the channel formation substrate 100 by alternately performing coating and etching. Moreover, it is possible to form blind holes and cause these holes to penetrate the channel formation substrate 100 by reducing the thickness of the channel formation substrate 100 by backgrinding or CMP.

In detail, assume a case where a resist is patterned from the second surface 112 of the channel formation substrate 100 by a photolithography technique, and the channel formation substrate 100 is processed by dry etching using Bosch process to, for example, process the common channels 132 with a depth of 475 μm. In this case, the recess portions 142 can be processed to have a depth of 250 to 300 μm. The recess portions 142 are shallower than the common channels 132 due to a microloading effect depending on a difference in opening area. Moreover, although the recess portions 142 can be formed by performing patterning and etching simultaneously with the common channels 132, in the case where the inner volumes of the recess portions 142 are to be individually adjusted, the recess portions 142 and the common channels 132 can be individually subjected to patterning and etching processes.

Similarly, the individual channels 134 are processed from the first surface 111 of the channel formation substrate 100, and the common channels 132 and the individual channels 134 are made to communicate with one another.

The support substrate 300 is made of silicon, and the thickness of the support substrate 300 is 725 μm. A resist is patterned by using the photolithography technique as in the channel formation substrate 100 from a fourth surface 312 opposite to the third surface 311 to be joined to the channel formation substrate 100, and a blind hole is processed to have a depth of 320 μm by dry etching using Bosch process. Then, the thickness of the substrate is reduced to 300 μm by backgrinding or CMP from the third surface 311 to cause the blind hole to penetrate the support substrate 300, and the pitch conversion channel 320 to be connected to the common channels 132 is formed.

Next, the adhesive agent transfer substrate is prepared, and a benzocyclobutene solution is spin-coated to have a thickness of 7 μm as the adhesive agent 200. A PET film is used as the transfer substrate. Moreover, the adhesive agent 200 is subjected to a bake process for five minutes at 100° C. to volatilize a solvent after the coating. The adhesive agent 200 is transferred to the channel formation substrate 100 by bringing the adhesive agent formed on the transfer substrate into contact with the second surface 112 of the channel formation substrate 100 while applying heat to the second surface 112. The thickness of the adhesive agent 200 after the transfer to the channel formation substrate 100 is 2.5 μm.

Moreover, the channel formation substrate 100 and the support substrate 300 are joined to each other by being heated in vacuum while being aligned with each other with a joining alignment apparatus. For example, the joining may be performed at a degree of vacuum of 100 Pa or lower and at temperature of 150° C. Protruding of the adhesive agent into the common channel 132 after the joining is checked, and the thickness of the protruding of the adhesive agent at the partition 136 forming the common channel 132 is a thickness equal to or smaller than the thickness of the protruding of the adhesive agent in a portion in the common channel 132 where no partition 136 is formed.

The channel formation substrate 100 and the support substrate 300 are joined and cooled, then taken out from the apparatus, and subjected to heat treatment for one hour at 250° C. under a nitrogen atmosphere in an oven to cure the adhesive agent.

Next, a dry film is transferred to the first surface 111 of the channel formation substrate 100, the dry film formed by spin-coating, onto a PET film, a substance in which a negative photosensitive resin is dissolved into a PGMEA solvent and drying the spin-coated substance at 100° C. with an oven. Then, the PET film is peeled off to form a photosensitive resin layer. A pattern to be the channels is exposed in the photosensitive resin layer, and then PEB is performed to obtain a latent image state. Next, a dry film is similarly stacked, and a pattern to be nozzles is exposed. Then, the channels and the nozzles are developed simultaneously by performing PEB, and a wafer for the liquid ejection head is completed.

In the wafer for the liquid ejection head, multiple modified layers are formed inside the silicon substrate in a thickness direction of the substrate (channel formation substrate 100 or support substrate 300) by stealth dicing using laser, and external force is applied to the wafer to cause cracking to progress between the modified portion and the modified portion. The wafer is thereby cut, and the liquid ejection substrate can be obtained.

### Embodiment 2

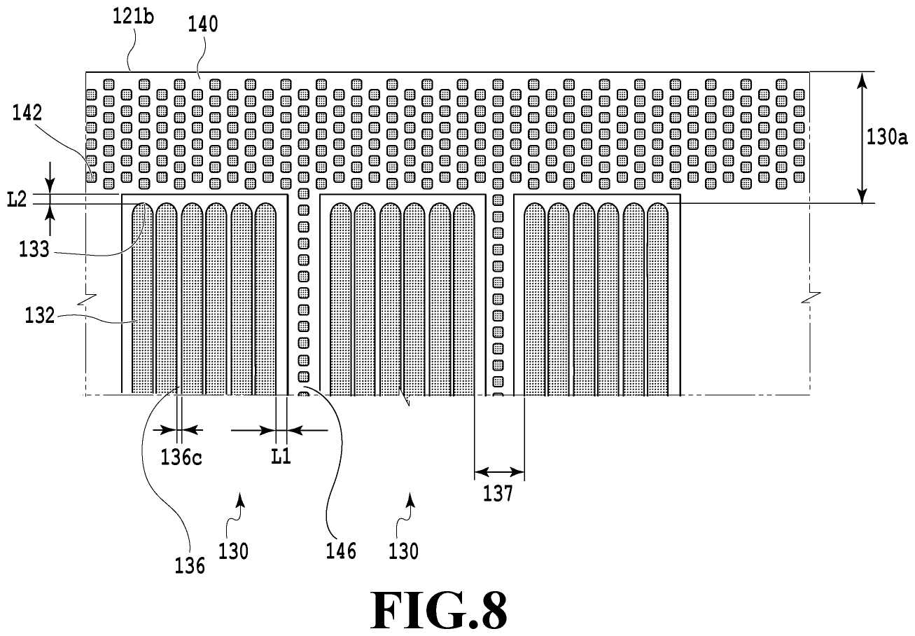

FIG. 8 is a diagram illustrating a liquid ejection substrate according to a second embodiment of the present disclosure, and illustrates the liquid ejection substrate from the support substrate side with the support substrate omitted. In the embodiment, the recess portions 142 are provided in a region adjacent to longitudinal direction end portions of the common channels 132. In detail, in the case where a distance 130a between an end portion 133 of each common channel 132 and the transverse direction end portion 121b of the channel formation substrate 100 is 150 μm or more in the channel region 130 formed by joining the channel formation substrate 100 and the support substrate 300 with the adhesive agent 200 and the thickness of the adhesive agent 200 is between 0.5 μm and 4.0 μm, the recess portions 142 are preferably provided. If no recess portions 142 are provided in this dimensional relationship, there is a possibility that the adhesive agent protrudes to the common channels 132 and the protruding causes blocking of the channels and the like.

In the embodiment, in the case where the distance 130a is 150 μm or more and the thickness of the adhesive agent 200 is 0.5 μm to 4.0 μm, the recess portions 142 are provided along the transverse direction end portion 121b of the channel formation substrate 100. Moreover, in the embodiment, there are multiple channel regions 130, an extended portion 146 of the joining region 140 is formed between each two adjacent channel regions 130, and the recess portions 142 are provided also in the extended portion 146. The joining region 140 is desirably spaced away from the common channels 132 adjacent to the joining region 140 by a distance L2. For example, in order secure an adhesion surface area that enables stable joining of the channel formation substrate 100 and the support substrate 300, the distance L2 may be longer than the width 136c of the partitions 136 partitioning the common channels 132. This can secure a state where an adhesion surface area of the adhesive agent 200 and a region between the recess portions 142 and the partitions 136 is larger than the adhesion surface area of the adhesive agent 200 and one partition 136, and can improve the reliability of the liquid ejection head.

In the embodiment, the distance 130a between the end portions 133 of the common channels 132 to the transverse direction end portion 121b of the channel formation substrate 100 is 150 μm or more, and a distance 137 between the two adjacent channel regions 130 is 150 μm or more.

In the embodiment, providing the recess portions 142 in the channel formation substrate 100 suppresses protruding of the adhesive agent to the common channels 132 adjacent to the joining region 140 of the channel formation substrate 100 while maintaining the protruding amount of the adhesive agent of the partitions 136 partitioning the common channels 132 in the case where the channel formation substrate 100 is joined to the support substrate 300 via the adhesive agent 200. This can prevent occurrence of leakage between the common channels 132, and a liquid ejection substrate with high reliability can be obtained.

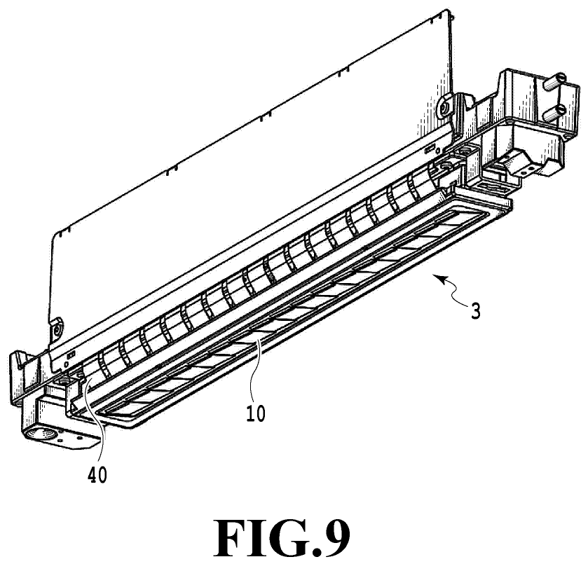

FIG. 9 is a perspective diagram illustrating the liquid ejection head according to one embodiment of the present disclosure. As illustrated in FIG. 9, a liquid ejection head 3 is formed by joining multiple liquid ejection substrates 10 having the above-mentioned configuration. In detail, the liquid ejection head 3 is a line liquid ejection head in which 17 liquid ejection substrates 10 capable of ejecting the ink is aligned (arranged in line). The liquid ejection head 3 includes a signal input terminal and an electric power supply terminal electrically connected to each of the liquid ejection substrates 10 via a flexible wiring board 40.

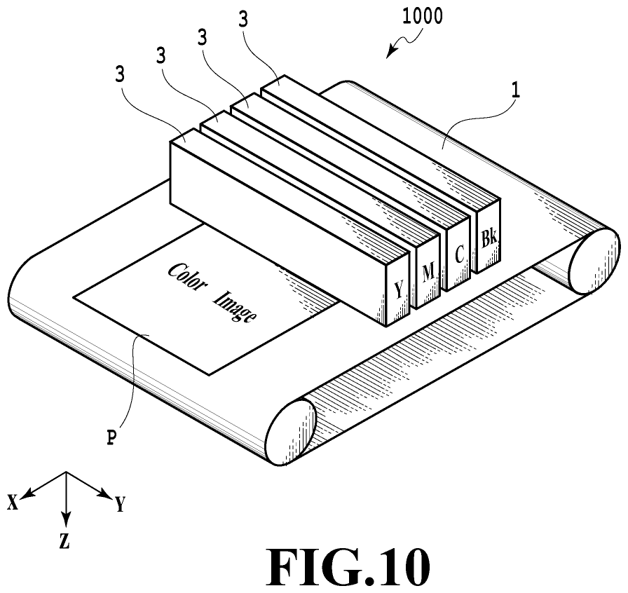

FIG. 10 is a perspective diagram schematically illustrating an inkjet printing apparatus according to one embodiment of the liquid ejection apparatus. The inkjet printing apparatus 1000 includes the liquid ejection heads 3 that eject inks of cyan (C), magenta (M), yellow (Y), and black (Bk). The printing apparatus 1000 prints an image on a print medium P by ejecting the inks from the liquid ejection heads 3 to the print medium P according to print data. In FIG. 10, the X direction is a conveyance direction of the print medium P, the Y direction is a width direction of the print medium, and the Z direction is a vertical upward direction.

Note that the liquid ejection apparatus is not limited to the printing apparatus as described above. For example, the liquid ejection apparatus may be a single-function printer that has only the printing function, or a multi-function printer that has multiple functions such as the printing function, the FAX function, and the scanner function. Moreover, the liquid ejection apparatus may be a manufacturing apparatus for manufacturing a color filter, an electronic device, an optical device, a microstructure, or the like by a predetermined printing method, an apparatus for generating fine air bubbles, or the like.

According to the above configuration, it is possible to suppress protruding of an adhesive agent from a joining region in a portion where no channels are formed such as partitions, while allowing protruding of the adhesive agent in the case where substrates are joined to each other in a liquid ejection head.

### Other Embodiments

It is apparent from the above explanation that any combination of the first and second embodiments described above are included in the embodiments of the invention unless the combination is contrary to the spirit of the invention.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-137462, filed Aug. 25, 2023, which is hereby incorporated by reference wherein in its entirety.

What is claimed is:

1. A liquid ejection head comprising a liquid ejection substrate configured to eject liquid, wherein
the liquid ejection substrate is configured to include a first substrate in which a channel for the liquid is formed and a second substrate joined to a first surface of the first substrate via an adhesive agent,
the first substrate has, as viewed in a direction perpendicular to the first surface,
a channel region including a plurality of the channels for the liquid and a partition sectioning the adjacent channels for the liquid from each other, and
a joining region adjacent to the channel region and including a recess portion open on the first surface, and
the adhesive agent is accommodated in the recess portion.

2. A liquid ejection head comprising a liquid ejection substrate configured to eject liquid, wherein
the liquid ejection substrate is configured to include a first substrate in which a channel for the liquid is formed and a second substrate joined to the first substrate via an adhesive agent,
the first substrate includes a joining region that is a region joined to the second substrate and that is adjacent to the channel only on one side in the first substrate, and a recess portion is formed in the joining region, and
the adhesive agent is accommodated in the recess portion.

3. The liquid ejection head according to claim 2, wherein the first substrate includes a partition configured to form the channel for the liquid.

4. The liquid ejection head according to claim 1, wherein a distance between the recess portion and the partition adjacent to the recess portion is larger than a width of the partition.

5. The liquid ejection head according to claim 1, wherein an opening of the recess portion has a quadrangle shape.

6. The liquid ejection head according to claim 1, wherein, in the joining region, an opening ratio of the recess portion per unit area is 5% to 30%.

7. The liquid ejection head according to claim 1, wherein the recess portion is provided along a longitudinal direction end portion of the first substrate.

8. The liquid ejection head according to claim 1, wherein the recess portion is provided along a transverse direction end portion of the first substrate.

9. The liquid ejection head according to claim 1, wherein a plurality of the recess portions are provided, are aligned in a longitudinal direction of the channel, and are aligned with the recess portions in every other row, in a direction orthogonal to the longitudinal direction of the channel.

10. The liquid ejection head according to claim 1, wherein a distance between an end of the recess portion in the joining region and an end of the channel region adjacent to the joining region is 150 μm or more.

11. The liquid ejection head according to claim 1, wherein, as viewed in a direction perpendicular to the first surface,
the plurality of channels and the partition extend in a first direction, and
the joining region is adjacent to the channel region in a second direction orthogonal to the first direction.

12. The liquid ejection head according to claim 1, further comprising a nozzle layer that is joined to a second surface side of the first substrate and that includes a nozzle for ejecting the liquid, the second surface being an opposite surface to the first surface of the first substrate.

13. The liquid ejection head according to claim 12, wherein the channels are common channels that supply the liquid to a plurality of the nozzles.

14. A liquid ejection apparatus comprising a liquid ejection head including a liquid ejection substrate configured to eject liquid, wherein
the liquid ejection substrate is configured to include a first substrate in which a channel for the liquid is formed and a second substrate joined to a first surface of the first substrate via an adhesive agent,
the first substrate includes, as viewed in a direction perpendicular to the first surface,
a channel region including a plurality of the channels for the liquid and a partition sectioning the adjacent channels for the liquid from each other, and
a joining region adjacent to the channel region and including a recess portion open on the first surface,
the adhesive agent is accommodated in the recess portion, and
the liquid ejection apparatus performs printing by ejecting ink from the liquid ejection head to a print medium.

15. A manufacturing method of a liquid ejection head comprising a liquid ejection substrate configured to eject liquid, wherein
the liquid ejection substrate is configured to include a first substrate in which a channel for the liquid is formed and a second substrate,
the first substrate has, as viewed in a direction perpendicular to the first surface,
a channel region including a plurality of the channels for the liquid and a partition sectioning the adjacent channels for the liquid from each other, and
a joining region adjacent to the channel region and including a recess portion open on the first surface,
the method including joining to a first surface of the first substrate via an adhesive agent, wherein the adhesive agent is accommodated in the recess portion.

16. The method according to claim 15 wherein a thickness of the adhesive agent is 0.5 to 4.0 μm in a case where the second substrate is joined to the joining region of the first substrate.
